(19) United States
(12) Patent Application Publication
(10) Pub. No.: US 2019/0196868 A1
(43) Pub. Date: Jun. 27, 2019

(54) SYSTEM

(71) Applicant: Onkyo Corporation, Osaka (JP)

(72) Inventors: Mitsuhiko TOKUDA, Osaka (JP); Hiroko YOSHIZAKI, Osaka (JP)

(21) Appl. No.: 16/213,259

(22) Filed: Dec. 7, 2018

(30) Foreign Application Priority Data
Dec. 22, 2017 (JP) 2017-246864

(51) Int. Cl. G06F 9/48; G06Q 30/06; G06Q 20/14; G01C 21/36

(52) U.S. Cl. CPC G06F 9/4843; G01C 21/3679; G06Q 20/14; G06Q 30/0631

(57) ABSTRACT

A system configured to activate a second application when a first application activates and a predetermined condition is met.

### CROSS-REFERENCE TO RELATED APPLICATIONS

This application claims priority to Japanese Application No. 2017-246864, filed Dec. 22, 2017, the entire contents of which are incorporated herein by reference.

### FIELD

The present disclosure relates to a system which has an application.

### BACKGROUND

For example, in a car navigation device, technology which asks whether or not introducing place of meal at a predetermined time is disclosed in JP 2000-266551 A. In the car navigation device, it is possible to introduce restaurant information to a user based on map information because map information, restaurant information, time information and so on are managed centrally.

In recent years, in a smartphone or the like, there are a navigation application which navigates the user to a destination, a restaurant guide application which introduces recommended restaurants, and a schedule application manages user schedule. However, operators of these applications are different, and these applications are separate applications. Therefore, things which can be realized in the car navigation device as described above cannot be realized. Further, for example, there are multiple restaurant applications, and information in the applications is different from one another. In the car navigation device, the user can only use one piece of restaurant information. Further, for example, when the restaurant guide application introduces a restaurant to the user and the user actually uses the introduced restaurant, it is thought that an operator of the restaurant obtains advertisement revenue, however, the car navigation device cannot realize it.

### SUMMARY OF THE DISCLOSURE

According to one aspect of the disclosure, there is provided a system configured to activate a second application when a first application activates and a predetermined condition is met.

### BRIEF DESCRIPTION OF THE DRAWINGS

FIG. 1 is a diagram illustrating a constitution of a system according to an embodiment of the present disclosure.

FIG. 2 is a diagram illustrating a constitution of a system of another example.

FIG. 3 is a diagram illustrating a constitution of a system of another example.

### DETAILED DESCRIPTION OF THE PREFERRED EMBODIMENTS

An objective of the present disclosure is to be able to perform collaboration between applications. Further, another objective of the present disclosure is to be able to obtain appropriate information for a user. Further, still another objective of the present disclosure is to be able to obtain advertisement revenue for an operator of an application.

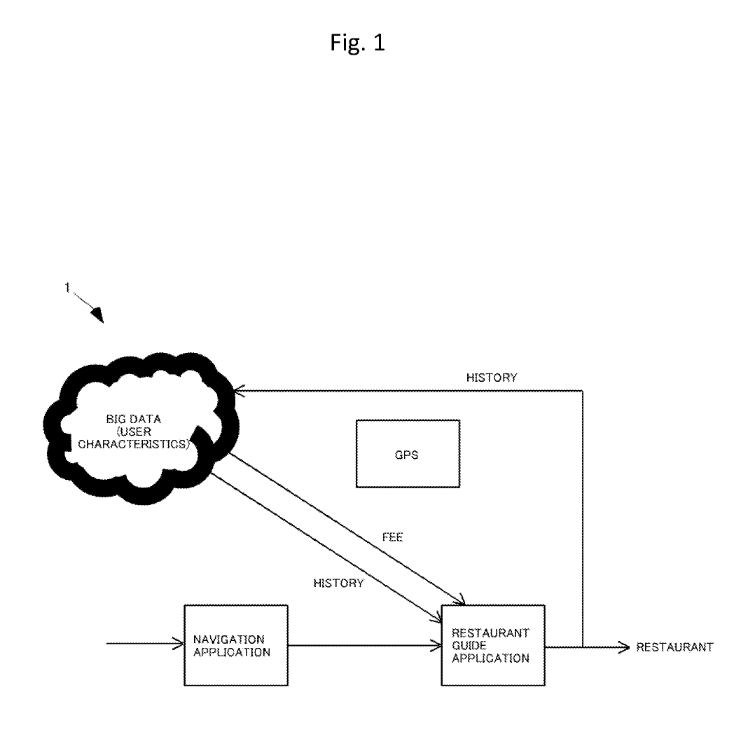

An embodiment of the present disclosure is described below. FIG. 1 is a diagram illustrating a constitution of a system according to an embodiment of the present disclosure. In the present embodiment, an application is executed on a system 1. Herein, the system 1 may be an electronic device such as a smartphone or the like or may be a cloud server. Further, the system 1 may be composed by collaborating the electronic device such as the smartphone or the like and the cloud server.

The system 1 activates the application. The system 1 receives user operation by a hand, voice and so on. For example, as illustrated in FIG. 1, the system 1 activates a navigation application (first application) based on the user operation. The navigation application receives the user operation and sets a destination. The navigation application navigates the user to the set destination by using the GPS (Global Positioning System).

When the user is navigated to the destination by the navigation application, namely, a condition of place that is the destination is met, the system 1 activates the other application (second application). In this time, the system 1 decides an application to activate from among multiple applications based on big data in which user characteristics are stored. For example, big data is stored in the cloud server, and multiple user characteristics are stored. Herein, for example, user characteristics are application use history of a user. For example, when use history of the restaurant guide application is high as application use history of the user, the system 1 activates the restaurant guide application.

The restaurant guide application introduces a nearby recommended restaurant to the user. For example, the restaurant guide application identifies a restaurant which is used by the user based on GPS. Further, for example, when the user writes a review with regard to the restaurant which is used by the user, the restaurant guide application identifies the restaurant the review of which is written by the user as a restaurant which is used by the user. The restaurant guide application sends restaurant use history (information of the restaurant which is used) to the cloud server in which big data is stored.

The cloud server receives the restaurant use history and stores the received restaurant use history in big data as user characteristics. The system 1 uses the big data (restaurant use history) and pays a predetermined amount of fee to the operator of the restaurant guide application as advertisement revenue. In this manner, when a restaurant is used (revenue feedback is performed) according to restaurant information which is introduced by the restaurant guide application, the system 1 pays fee to the operator of the restaurant guide application. Herein, a case where the restaurant guide application introduces restaurant information and the restaurant is used as revenue feedback is illustrated. Not limited to this, for example, when a shopping application introduces goods information and goods is bought as revenue feedback, fee may be payed to an operator of the shopping application.

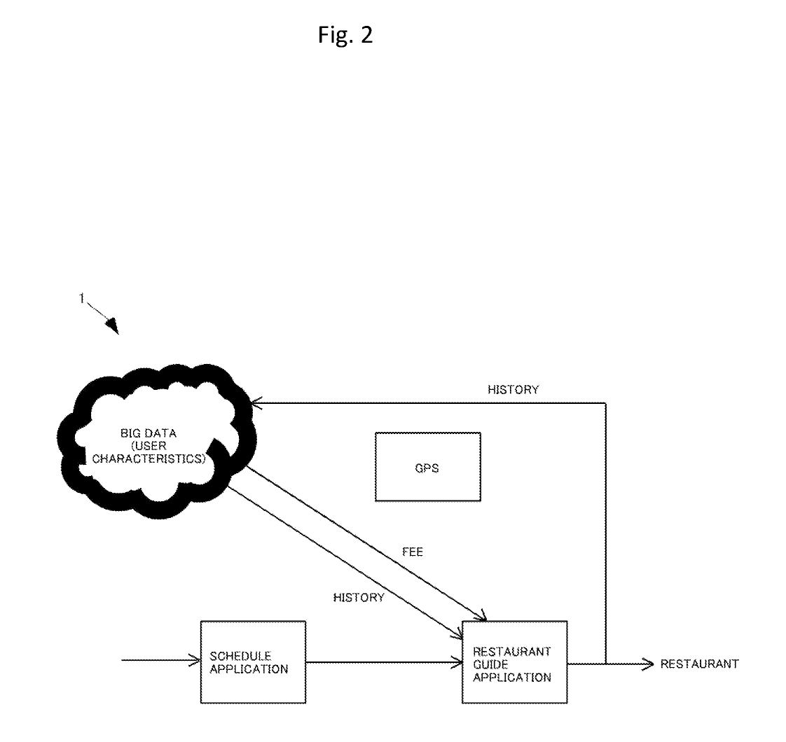

FIG. 2 is a diagram illustrating a system of the other example. As illustrated in FIG. 2, the system 1 activates a schedule application (first application) which manages schedule. The schedule application is an application which operates in background and always activates. The schedule application receives user operation and set schedule, for example, the schedule of “19 o'clock dinner” is set.

When a predetermined time comes and time of schedule which is set is detected by the schedule application, namely, a condition of time that is schedule is met, the system 1 activates the other application (second application). For example, when schedule which is detected by the schedule application is “dinner”, the system 1 activates the restaurant guide application. Herein, when there are multiple restaurant guide applications, the system 1 decides a restaurant application to be activated based on big data in which user characteristics are stored. For example, as user application use history, in an A restaurant guide application and a B restaurant guide application, when use history of the B restaurant guide application is high, the system 1 activates the B restaurant guide application. Subsequent processing is the same as operation illustrated in FIG. 1.

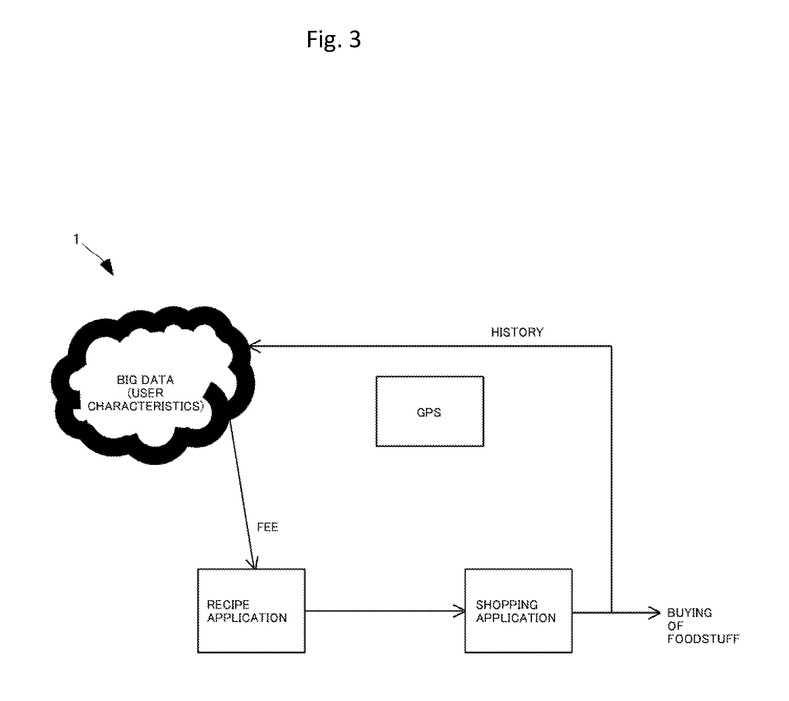

FIG. 3 is a diagram illustrating a constitution of a system of the other example. The system 1 activates a recipe application (first application). The recipe application introduces recipe of cooking to a user. Namely, the recipe application presents information such as recipe. The recipe application receives selection of recipe by the user. When presented recipe (information) is selected by the recipe application, the system 1 activates a shopping application (second application) which can buy foodstuff of the recipe. The shopping application presents the foodstuff of the recipe and urges the user to purchase. When presented foodstuff is bought, the shopping application sends buying history to the cloud server.

The cloud server receives the buying history of foodstuff and stores the received buying history of foodstuff in big data as user characteristics. The system. 1 uses the big data (buying history of foodstuff) and pays a predetermined amount of fee to an operator of the recipe application which introduces to the shopping application as advertisement revenue. In this manner, when revenue feedback such as buying of foodstuff is done based on information which is presented by the shopping application, the system 1 pays fee to the operator of the recipe application.

As described above, in the present embodiment, when the system 1 activates the navigation application (first application) and navigation to a destination is performed by the navigation application, the system 1 activates the restaurant guide application (second application), for example. Thus, collaboration between applications (the navigation application and the restaurant guide application) can be performed.

Further, in the present embodiment, when the system 1 activates the schedule application (first application) and time of schedule is detected by the schedule application, the system 1 activates the restaurant guide application (second application), for example. Thus, collaboration between applications (the schedule application and the restaurant guide application) can be performed.

Further, in the present embodiment, the system 1 decides an application to be activated from among multiple applications based on user characteristics (for example, application use history) and activates the decided application. For example, when use history of the restaurant guide application is high, the system 1 decides an application to be activated as the restaurant application, and activates the decided restaurant guide application. Thus, an appropriate application is activated based on user characteristics and it is possible to provide appropriate information to the user.

In the present embodiment, when revenue is fed back (for example, use of a restaurant) according to information which is introduced by the application, the system 1 pays fee to the operator of the application. Thus, the operator of the application can obtain advertisement revenue.

Further, in the present embodiment, when the system 1 activates the recipe application (first application) and recipe (information) which is presented by the recipe application is selected, the system 1 activates the shopping application (second application). Thus, collaboration between applications (the recipe application and the shopping application) can be performed.

In the present embodiment, when revenue such as buying of foodstuff is fed back based on information which is presented by the shopping application (second application), fee is payed to the operator of the recipe application (second application). Thus, the operator of the recipe application can obtain advertisement revenue.

The embodiment of the present disclosure is described above, but the mode to which the present disclosure is applicable is not limited to the above embodiment and can be suitably varied without departing from the scope of the present disclosure as illustrated below.

In the above described embodiment, the navigation application, the restaurant guide application, the schedule application, the recipe application, and the shopping application are illustrated as applications, but applications are not limited to these. Further, a case where the restaurant application activates in activating of the navigation application is illustrated, however, the navigation application may activate in activating of the restaurant guide application.

The present disclosure can be suitably employed in a system which has an application.

What is claimed is:

1. A system configured to activate a second application when a first application activates and a predetermined condition is met.

2. The system according to claim 1,
wherein the predetermined condition is a place.

3. The system according to claim 1,
wherein the first application is a navigation application,
the second application is a restaurant guide application,
and further configured to activate the restaurant guide application when navigation to a destination is performed by the navigation application.

4. The system according to claim 1,
wherein the predetermined condition is time.

5. The system according to claim 1,
wherein the first application is a schedule application,
the second application is a restaurant guide application,
and further configured to activate the restaurant guide application when a time of schedule is detected by the schedule application.

6. A system configured to decide an application to be activated from among multiple applications based on user characteristics, and
activate a decided application.

7. The system according to claim 6,
wherein the user characteristics are application use history.

8. The system according to claim 6,
wherein the multiple user characteristics are stored in a cloud server as big data.

9. The system according to claim 6,
further configured to activate a restaurant guide application when use history of the restaurant guide application is high as the user characteristics.

10. A system configured to pay a fee to an operator of an application when revenue is fed back according to information which is introduced by the application.

11. The system according to claim 10,
wherein the application is a restaurant guide application,
further configured to pay a fee to an operator of the restaurant guide application when a restaurant is used according to restaurant information which is introduced by the restaurant guide application.

12. The system according to claim 11,
wherein the restaurant guide application identifies a used restaurant based on GPS.

13. The system according to claim 11,
wherein the restaurant guide application identifies a restaurant a review of which is written as a used restaurant when the review is written.

14. The system according to any one of claim 11,
wherein the restaurant guide application identifies a used restaurant, and sends use history of the identified restaurant to a cloud server which stores user characteristic as big data.

15. The system according to claim 1,
further configured to activate the second application when the first application is activated and information which is presented by the first application is selected.

16. The system according to claim 15, further configured to pay a fee to an operator of the first application when revenue is fed back based on information which is presented by the second application.

17. The system according to claim 15,
wherein the first application is a recipe application,
and the second application is a shopping application,
further configured to activate the shopping application when information which is presented by the recipe application is selected.

18. The system according to claim 17,
wherein the shopping application presents foodstuff of recipe,
further configured to pay a fee to an operator of the recipe application when foodstuff which is presented by the shopping application is bought.

19. The system according to claim 18,
wherein the shopping application sends foodstuff buying history to a cloud server which stores user characteristics as big data.
